(19) United States
(12) Patent Application Publication
(10) Pub. No.: US 2009/0254743 A1
(43) Pub. Date: Oct. 8, 2009

(54) FLEXABLE AUDIO DATA TRANSMISSION METHOD FOR TRANSMITTING ENCRYPTED AUDIO DATA, AUDIO PROCESSING SYSTEM AND COMPUTER SYSTEM THEREOF

(76) Inventors: Shu-Yeh Chiu, Hsinchu County (TW); Tsung-Li Yeh, Penghu County (TW); Chia-Yu Hung, Taipei City (TW); Jung-Wen Kuo, Chiayi City (TW)

Correspondence Address: NORTH AMERICA INTELLECTUAL PROPERTY CORPORATION, P.O. BOX 506, MERRIFIELD, VA, 22116, US

(21) Appl. No.: 12/471,495

(22) Filed: May 26, 2009

Related U.S. Application Data
(63) Continuation-in-part of application No. 11/960,705, filed on Dec. 20, 2007.

(30) Foreign Application Priority Data
Dec. 21, 2006 (TW) 095148249

(51) Int. Cl. G06F 12/14; G06F 17/00

(52) U.S. Cl. 713/150; 700/94

(57) ABSTRACT

The present invention provides an audio data transmission method for transmitting encrypted audio data, an audio processing system and computer system thereof. The audio data transmission method includes providing an audio data, performing an encryption process upon the audio data according to an encryption standard and a format of the audio data, transmitting the encrypted audio data to an audio device according to a link standard, and utilizing the audio device to perform a decryption process upon the encrypted audio data.

### CROSS REFERENCE TO RELATED APPLICATIONS

This continuation-in-part application claims the benefit of co-pending U.S. patent application Ser. No. 11/960,705, filed on Dec. 20, 2007 and included herein by reference.

### BACKGROUND OF THE INVENTION

1. Field of the Invention

The invention relates to audio data transmission, and more particularly, to a method for encrypting audio data and then transmitting the encrypted audio data via a high definition audio link, and an apparatus thereof.

2. Description of the Prior Art

More and more consumers have moved their personal computers to their living rooms in order to enjoy digital music and movies with multi-channel audio systems and large-screen televisions. This trend indicates that consumers might consider connecting more advanced speakers to their computers; however, if the audio subsystem of the computer (whether integrated or external) cannot match the high level of the advanced speaker, the overall playing quality of the digital media will be influenced. In addition, reproducing two audio streams on the computer simultaneously is now a common request; for example, consumers might want to play a symphony in the study while playing a movie in the living room. This cannot be accomplished with conventional audio solutions. High Definition Audio (HD Audio) standard defined by Intel, however, are more advanced than previous audio standards. HD Audio can support up to 8 audio channels at 192 kHz/32 bits, while the conventional AC97 standard can only support up to 6 channels at 48 kHz/20 bits. Therefore, by introducing the new High Definition Audio standard, better audio quality could be achieved to satisfy users' needs.

However, no matter whether it is the currently commonly used AC97 standard or the newly developed HD Audio standard that is adopted, conventional computer systems and audio systems still use a data format that can be directly decoded and played, such as the pulse code modulation (PCM) format, to store and transmit audio data. This means that audio data are vulnerable to theft by illegal users (i.e., hackers) during the course of storage and transmission, leading to flawed protection of both personal privacy and intellectual property rights.

### SUMMARY OF THE INVENTION

Therefore, one of the objectives of the present invention is to introduce, in computer systems or audio systems, encryption techniques, which encrypt audio data during the course of audio data storage or transmission, so as to ensure that, even if the encrypted audio data is subject to theft by an illegal user, the actual content of the audio data will not be known because of the encryption.

According to an embodiment of the claimed invention, an audio processing system comprises a host system and an audio device. The host system is utilized to receive an audio data and perform an encryption process upon the audio data according to an encryption approach and a format of the audio data. The audio device coupled to the host system via a link standard is utilized to receive the audio data encrypted by the host system according to the link standard and perform a decryption process upon the encrypted audio data; wherein a data length of the encrypted audio data generated by the host system depends upon the format of the audio data.

According to another embodiment of the claimed invention, an audio data transmission method comprises performing an encryption process upon an audio data according to an encryption approach and a format of the audio data; transmitting the encrypted audio data to an audio device via a link standard; and utilizing the audio device to perform a decryption process upon the encrypted audio data; wherein a data length of the encrypted audio data depends on the format of the audio data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an encrypted audio data transmitting device according to an exemplary embodiment of the present invention.

FIG. 2 is a diagram of audio data complying with High Definition Audio standard.

FIG. 3 is a diagram illustrating the garbage-data padding and encryption process that the encrypted audio data transmitting device in FIG. 1 performs on the 48 kHz/2 ch/24 bit audio data to be transmitted according to the first exemplary implementation.

FIG. 4 is a diagram illustrating the garbage-data padding and encryption process that the encrypted audio data transmitting device in FIG. 1 performs on the 48 kHz/8 ch/24 bit audio data to be transmitted according to the first exemplary implementation.

FIG. 5 is a diagram illustrating the garbage-data padding and encryption process that the encrypted audio data transmitting device in FIG. 1 performs on the 192 kHz/2 ch/24 bit audio data to be transmitted according to the first exemplary implementation.

FIG. 6 is a diagram illustrating the garbage-data padding and encryption process that the encrypted audio data transmitting device in FIG. 1 performs on the 192 kHz/8 ch/24 bit audio data to be transmitted according to the first exemplary implementation.

FIG. 7 is a table showing a plurality of candidate nominal data lengths.

FIG. 8 is a diagram illustrating the garbage-data padding and encryption process that the encrypted audio data transmitting device in FIG. 1 performs on the 48 kHz/2 ch/24 bit audio data to be transmitted according to the second exemplary implementation.

FIG. 9 is a diagram illustrating the garbage-data padding and encryption process that the encrypted audio data transmitting device in FIG. 1 performs on the 48 kHz/8 ch/24 bit audio data to be transmitted according to the second exemplary implementation.

FIG. 10 is a diagram illustrating the garbage-data padding and encryption process that the encrypted audio data transmitting device in FIG. 1 performs on the 192 kHz/2 ch/24 bit audio data to be transmitted according to the second exemplary implementation.

FIG. 11 is a diagram illustrating the garbage-data padding and encryption process that the encrypted audio data transmitting device in FIG. 1 performs on the 192 kHz/8 ch/24 bit audio data to be transmitted according to the second exemplary implementation.

### DETAILED DESCRIPTION

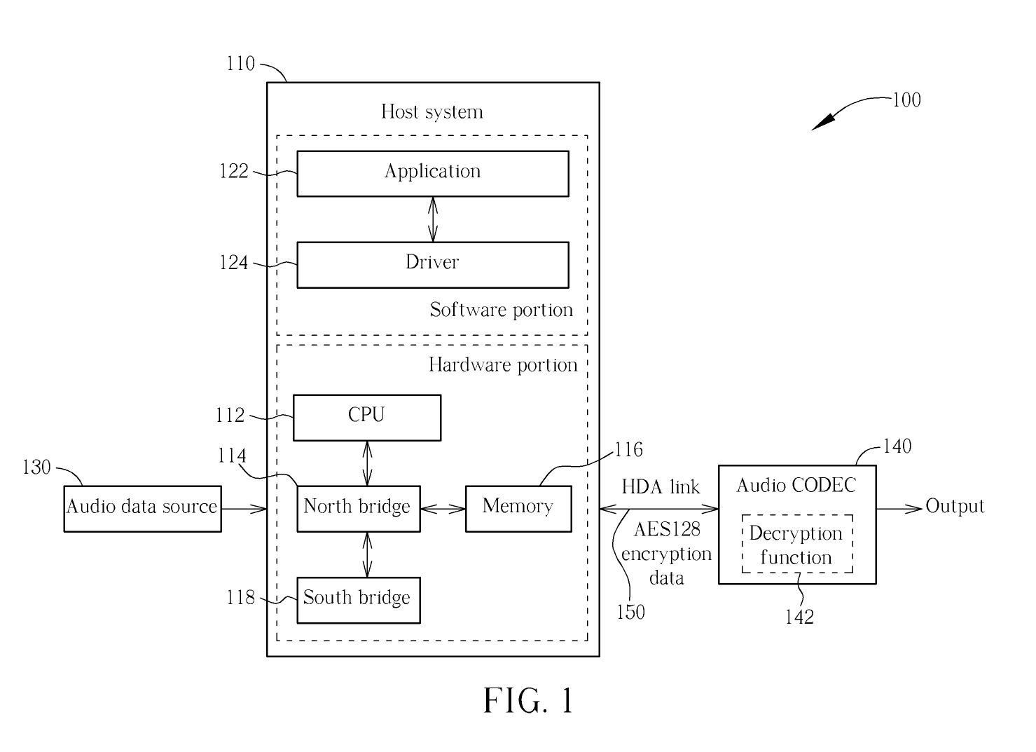

Please refer to FIG. 1, which is a diagram of an encrypted audio data transmitting device 100 according to an exemplary embodiment of the present invention. This embodiment takes a widely seen personal computer system as an example to illustrate the principle of the present invention; however, as those skilled in the art will readily observe, the application of the present invention is not limited to personal computer systems, and any audio system that might be invaded by an illegal user (for example, an audio system connected to the Internet) falls in the field to which the present invention applies. In this embodiment, the encrypted audio data transmitting device 100 shown in FIG. 1 comprises a host system 110, which, in this embodiment, is realized by a personal computer and its computational capacity. Such a host system 110 typically operates on a combination of a hardware portion and a software portion. In terms of hardware the host system 110 generally comprises a central processing unit (CPU) 112, a north bridge 114 coupled to the CPU 112, for communicating with a memory 116 and other units having fast accessing speed, a south bridge 118 coupled to the north bridge 114, for communicating with numerous peripheral devices of the host system 110, and other commonly known units not shown in FIG. 1. In terms of software the host system 110 generally comprises an upper layer application 122 and a lower layer driver 124. Commonly seen examples of the application 122 include multimedia processing and playing program, or any other programs implemented for processing the audio data. The driver 124 is utilized to handle communications between the hardware portion and the software portion. The host system 110 receives audio data from an audio data source 130, encrypts the audio data by utilizing the encryption function of the application 122, and transmits the encrypted audio data to an audio CODEC 140 via an audio link 150. Then the audio CODEC 140 decrypts the encrypted audio data for playing the audio data.

In this embodiment, the audio data source 140, which stores video and audio multimedia data, can be a DVD optical disc storage device, including those complying with next-generation DVD standards such as HD-DVD or Blu-ray specifications. However, the present invention is not limited to the above-mentioned embodiment; any device or signal source storing or transmitting audio data can be viewed as the audio data source 130 in FIG. 1. In order to work with the implementation of the present invention, the audio CODEC 140 is provided with a decryption function 142 in accordance with the encryption operation applied upon the audio data by the host system 110. The decryption function 142 of the audio CODEC 140 can be implemented by hardware, software or a combination thereof, which can be easily accomplished by those skilled in the art. Moreover, an HDA link with high transmission bandwidth is preferably adopted as the audio link 150 connecting the audio CODEC 140 and the host system 110 (more specifically the south bridge 118 in this embodiment), in order to accommodate the transmission of the encrypted audio data. However, as those skilled in the art can readily appreciate, the present invention is not limited by the above-mentioned embodiment; other conventional or innovative audio link techniques could also be utilized in the present invention.

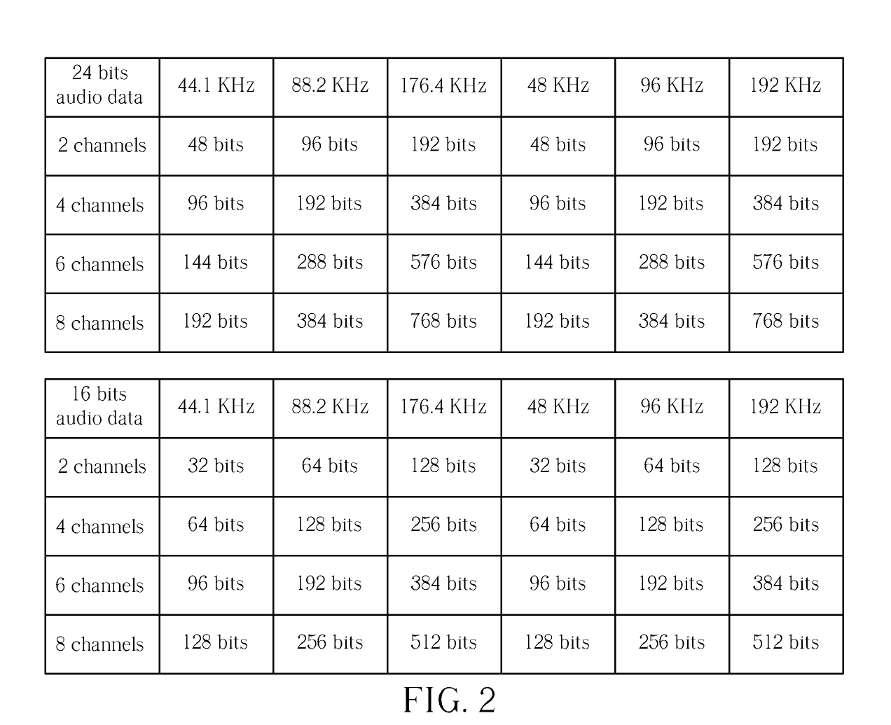

In a first exemplary implementation, the host system 110 uses an encryption approach to encrypt the audio data. For example, Advanced Encryption Standard (AES) is applicable to the encryption approach. But it should be noted that AES is only one example of the invention, other encryption approaches may be utilized to encrypt the audio data according to this invention. Please refer to the table in FIG. 2. In the HD Audio standard, a sampling rate for sampling the audio data can be chosen from the sampling rates of 44.1 kHz, 88.2 kHz, 176.4 kHz, 48 kHz, 96 kHz, and 192 kHz, and the HD audio output can contain 2, 4, 6, 8, or even more than 8 channels of audio data, wherein for each combination of configuration, data can be transmitted in unit of frames with a corresponding bit length. The encryption process of the present embodiment encrypts the audio data having different sampling rates and different channels into uniform 768-bit encrypted data. In other words, in the first exemplary implementation, the nominal data length has a fixed number of bits (i.e., 768 bits) regardless of the format of the audio data to be encrypted. If the length of the audio data before encryption is less than 768 bits (i.e., in most cases), garbage data will be padded into the frames before the encryption to make the total data length reach the fixed nominal data length. Then, the audio data along with the garbage data is transformed into six 128-bit (768 bits in total) encrypted data according to the AES128 standard.

Please note that the transmitting rate of the frames is 48 KHz in the HD Audio standard; therefore, the audio data having a sampling rate of 44.1 kHz needs to be processed additionally. In the first exemplary implementation, the additional process of the audio data whose sampling rate is 44.1 kHz is, for every 160 frames of the audio data transmitted, to insert cadences in a pattern of “12-11-11-12-11-11-12-11-11-12-11-11-11-(repeat)”, wherein the symbol means no data is transmitted, as prescribed in section 5.4 (pages 83-86) of “High Definition Audio Specification, Revision 1.0”, published on Apr. 15, 2004, by Intel Corporation. That is to say, in every 160 frames, there are 147 frames containing audio data and 13 frames having no audio data. The audio data whose sampling rate is 88.2 kHz or 176.4 kHz could be processed by the same principle. Since a skilled person will readily appreciate the above process after reading the disclosure, further description is herein omitted.

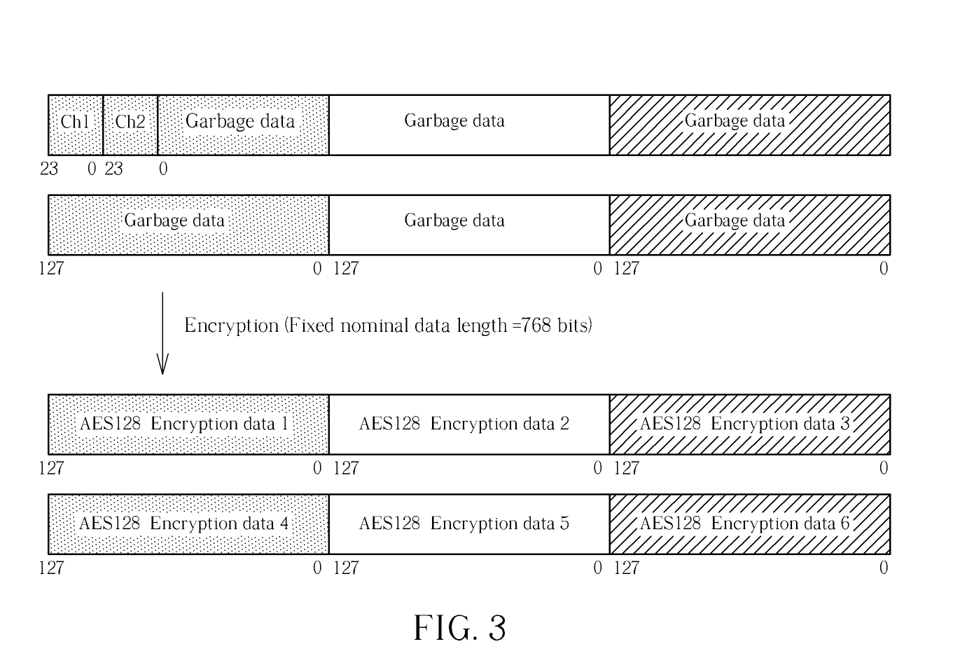

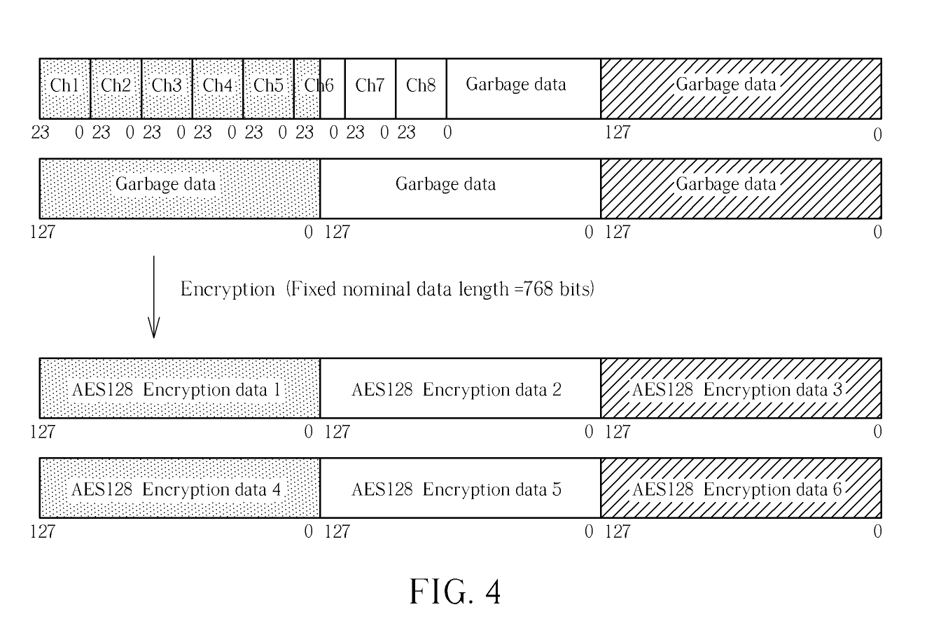

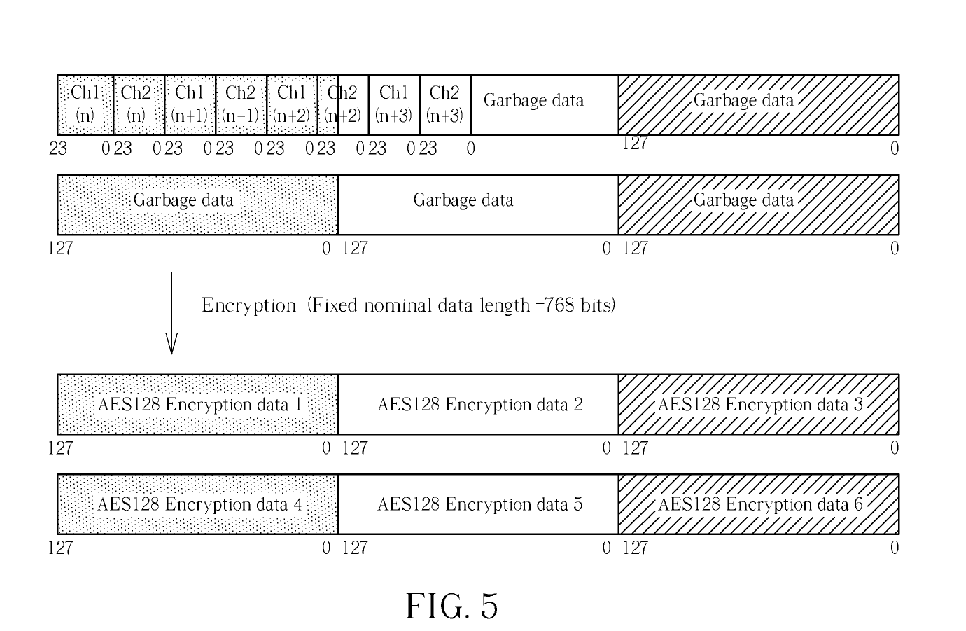

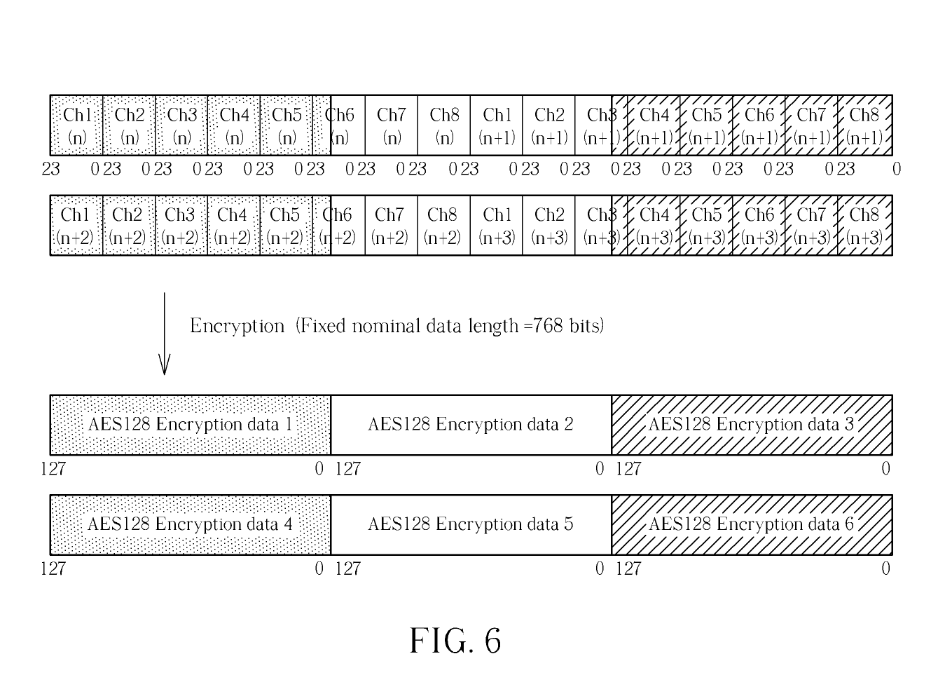

Please refer to FIG. 3, which illustrates the garbage-data padding and encryption process that the encrypted audio data transmitting device 100 in FIG. 1 performs on the 48 kHz/2 ch/24 bit audio data to be transmitted (i.e. the sampling rate is 48 kHz, 2 channels, and the data amount at each sampling of each channel is 24 bits) according to the first exemplary implementation. Because the nominal data length is 768 bits while the data amount of the audio data is only 48 bits (i.e. 24 bits*2 channels*1), the remaining 720 bits are padded with garbage data, making the data amount reach the nominal amount, i.e., 768 bits. Then the 768-bit data is encrypted to form six 128-bit encrypted data, and the encrypted data is stored in a memory device before it is transmitted to the audio CODEC 140 via the HDA link 150. Similarly, FIG. 4, FIG. 5 and FIG. 6 illustrate the respective garbage-data padding and encryption process that the encrypted audio data transmitting device 100 in FIG. 1 performs on the 48 kHz/8 ch/24 bit, 192 kHz/2 ch/24 bit, and 192 kHz/8 ch/24 bit audio data to be transmitted.

With regard to the first exemplary implementation mentioned above, the nominal data length has a fixed number of bits (i.e., 768 bits) regardless of the data format of the incoming audio data to be encrypted. That is, no matter how many valid bits are included in the audio data before the encryption process commences, garbage-data padding will be used to ensure that the data amount processed by the following encryption process (i.e., e.g., the AES128 encryption) is always equal to the nominal data length, say, 768 bits. As a result, six 128-bit (768 bits in total) encrypted data are derived per each AES128 encryption. The encrypted data each having 768 bits may occupy a great deal of the available bandwidth of the HDA link 150 between the host system 110 and the audio CODEC 140 and necessitate redundant decryption cycles of the audio CODEC 140. To improve the utilization of the available bandwidth of the HAD link and reduce the decryption cycles of the audio CODEC 140, the present invention further proposes a second exemplary implementation which selects a nominal data length for the audio data to be encrypted from a plurality of candidate nominal data lengths according to the format of the audio data, where the format of the audio data comprises at least one of a sampling rate, a number of bits per sample, and a number of audio channels. Further details of the second exemplary implementation are illustrated as follows.

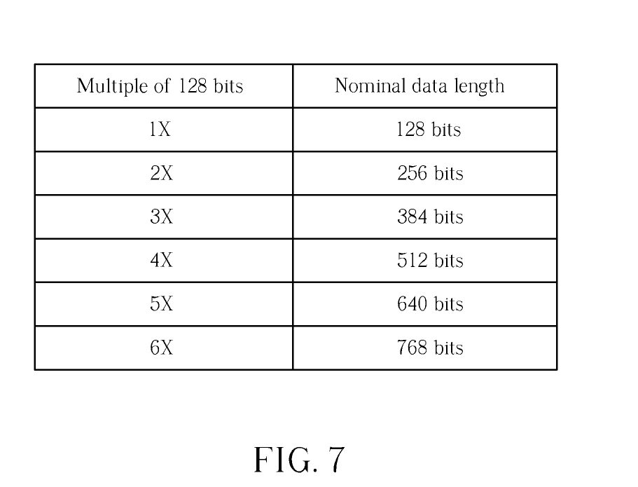

FIG. 7 is a table showing a plurality of candidate nominal data lengths, including 128 bits (1×128 bits), 256 bits (2×128 bits), 384 bits (3×128 bits), 512 bits (4×128 bits), 640 bits (5×128 bits), and 768 bits (6×128 bits), for the AES128 encryption. In the second exemplary implementation, the encryption process selects one of the candidate nominal data lengths which is not less than and closest to the number of valid bits included in the audio data to be encrypted, and then encrypts the audio data according to the selected nominal data length. Therefore, the encryption process encrypts the audio data having different sampling rates and different channels into encrypted data with different bits (128, 256, 384, 512, 640 or 728 bits), depending upon the format of the audio data. Similarly, if the length of the audio data before encryption is less than the selected nominal data length (i.e., in most cases), garbage data will be padded into the frames before the encryption to make the total data length reach the selected nominal data length. As a person skilled in the art would readily understand the operation of the garbage-data padding after reading above paragraphs, further description is omitted here for brevity. Then, the audio data along with the garbage data is transformed into one or multiple 128-bit encrypted data according to the AES128 standard. Specifically, the AES128 encryption generates one 128-bit encrypted data when the selected nominal data length is 128 bits, generates two 128-bit encrypted data when the selected nominal data length is 256 bits, generates three 128-bit encrypted data when the selected nominal data length is 384 bits, generates four 128-bit encrypted data when the selected nominal data length is 512 bits, generates five 128-bit encrypted data when the selected nominal data length is 640 bits, and generates six 128-bit encrypted data when the selected nominal data length is 768 bits.

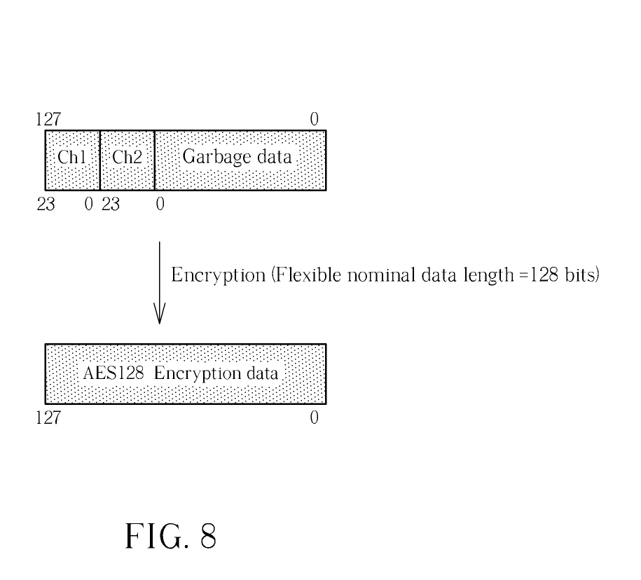

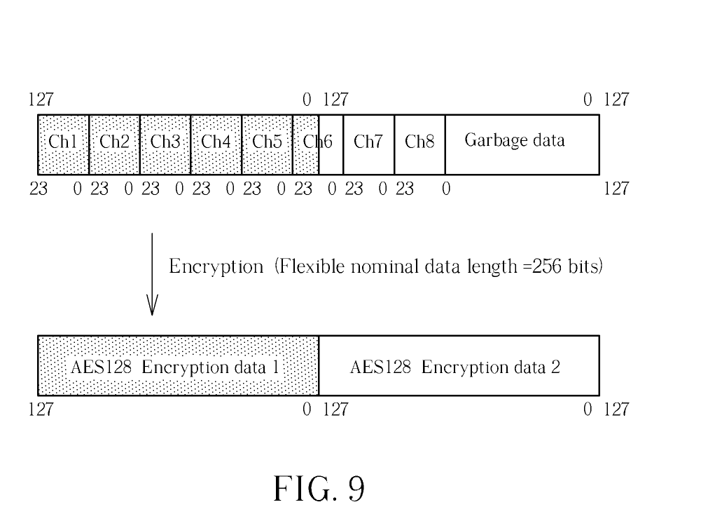

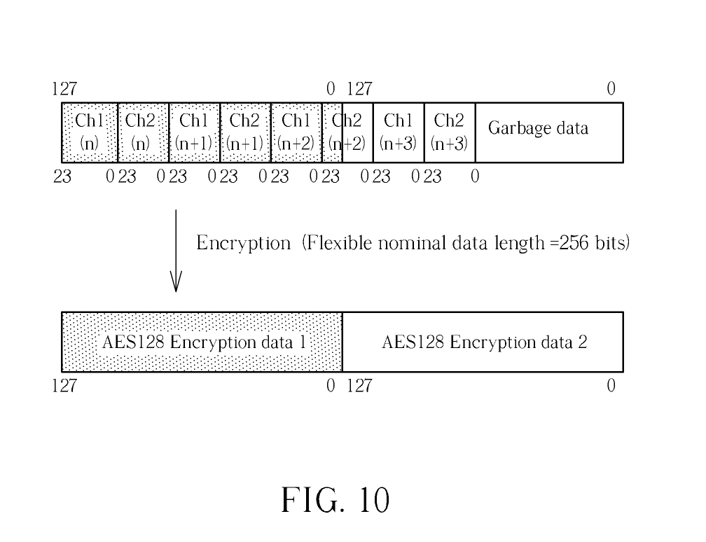

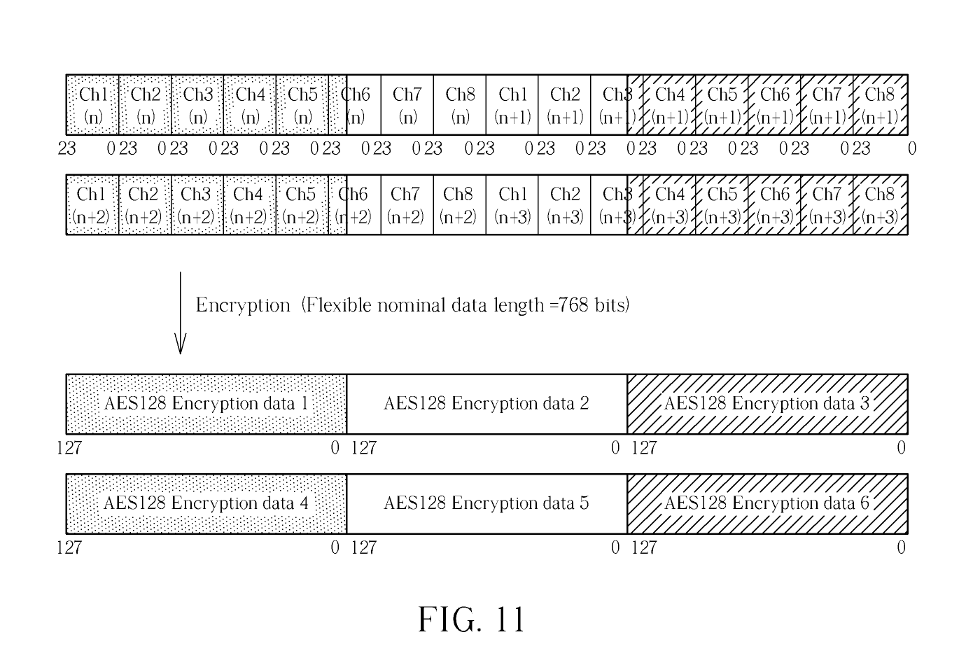

Please refer to FIG. 8, which illustrates the garbage-data padding and encryption process that the encrypted audio data transmitting device 100 in FIG. 1 performs on the 48 kHz/2 ch/24 bit audio data to be transmitted (i.e. the sampling rate is 48 kHz, 2 channels, and the data amount at each sampling of each channel is 24 bits) according to the second exemplary implementation. As the number of valid bits included in the audio data is equal to 48, the selected nominal data length would be 128 bits. Because the selected nominal data amount is 128 bits while the data amount of the audio data is only 48 bits (i.e. 24 bits*2 channels*1), the remaining 80 bits are padded with garbage data, making the data amount reach the nominal data length, i.e., 128 bits. Then the 128-bit data is encrypted to form one 128-bit encrypted data, and the encrypted data is stored in a memory device before it is transmitted to the audio CODEC 140 via the HDA link 150. Similarly, FIG. 9, FIG. 10 and FIG. 11 illustrate the respective garbage-data padding and encryption process that the encrypted audio data transmitting device 100 in FIG. 1 performs on the 48 kHz/8 ch/24 bit, 192 kHz/2 ch/24 bit, and 192 kHz/8 ch/24 bit audio data to be transmitted according to the second exemplary implementation.

Briefly summarized, as the nominal data length depends upon the format of the audio data to be encrypted, the nominal data length is not always equal to 768 bits in the second exemplary implementation. Therefore, the amount of garbage data appended to the audio data is adjustable, depending upon the selected nominal data length. Compared to the first exemplary implementation mentioned above, the second exemplary implementation can effectively reduce the length of the padded garbage data, thereby mitigating load of the audio CODEC 140 on decryption, mitigating load of the host system 110 on encryption, and improving the utilization of the available bandwidth of the HAD link to maximize the data throughput. The overall power consumption can be reduced greatly. Besides, the utilization efficiency of the DMA (Direct Memory Access) buffer of the host system 110 can be improved. Furthermore, as the nominal data length is not a fixed value, the encryption effect and security level of the audio data to be transmitted is enhanced accordingly. Furthermore, as the audio data format is not fixed, there is no need to insert cadences for transmission of audio data whose sampling rate is 44.1 KHz, 88.2 kHz or 176.4 kHz. The loads of the host system 110 and the audio CODEC 140 are further mitigated. In this way, the overall power consumption is further reduced.

The detailed operating procedure of the AES encryption standard utilized in the present invention will be readily appreciated by a skilled person after reading the disclosure of the present invention; therefore, further description is herein omitted. Those skilled in encryption techniques should understand that the encrypted audio data transmitting device 100 and the encryption method thereof are not limited to apply the AES encryption standard; other encryption techniques that could achieve the objective of data security during transmission or storage of the audio data can also be adopted in the present invention. Although the present invention is not limited to using HDA links, since a significant amount of non-audio data, such as padded garbage data, is introduced to increase the security of encryption when the audio data is encrypted according to AES or other encryption standards, it is preferred that the link used to transmit encrypted data has a high transmission bandwidth, such as HDA link or other serial links. Moreover, the audio data received from the audio data source 130 by the host system 110 may include other standardized or proprietary encryption format. In this situation, the present invention is still applicable as long as the software portion of the host system 110 (i.e., the application 122 and the driver 124) can decrypt, conforming to said standardized or proprietary encryption format, the audio data before performing the designed encryption (i.e., AES128) of the present invention.

Briefly summarized, the present invention utilizes software to encrypt and protect audio data in order to prevent theft of said audio data by illegal users during transmission and storage. When the audio device (e.g., the audio CODEC 140) utilized for processing and playing audio data receives the encrypted data, it can obtain the original audio data by decrypting the encrypted data, thereby achieving the objective of securing the contents of the audio data.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An audio processing system, comprising:
a host system, for receiving an audio data and encrypting the audio data according to an encryption approach and a format of the audio data so as to generate an encrypted audio data; and
an audio device, coupled to the host system via an interface, for receiving the encrypted audio data via the interface and performing a decryption process upon the encrypted audio data;
wherein a data length of the encrypted audio data generated by the host system depends upon the format of the audio data.

2. The audio processing system of claim 1, wherein the format of the audio data comprises at least one of a sampling rate, a number of bits per sample, and a number of audio channels.

3. The audio processing system of claim 1, wherein the host system selects a data length from a plurality of candidate data lengths according to the format of the audio data, and encrypts the audio data according to the encryption approach and the selected data length.

4. The audio processing system of claim 1, wherein the host system is a personal computer.

5. The audio processing system of claim 4, wherein the host system further comprises an application, for performing the encryption process.

6. The audio processing system of claim 1, wherein the encryption approach is an AES encryption standard.

7. The audio processing system of claim 1, wherein the interface is in conformity with an HDA link.

8. The audio processing system of claim 7, wherein the audio device is coupled to a southbridge of the host system via the HDA link.

9. The audio processing system of claim 1, wherein the audio device is an audio CODEC.

10. The audio processing system of claim 1, wherein the audio data source received by the host system is from a DVD optical disc storage device.

11. An audio data transmitting method, comprising:
performing an encryption process upon an audio data according to an encryption approach and a format of the audio data so as to generate an encrypted audio data;
transmitting the encrypted audio data to an audio device according to a link standard; and
utilizing the audio device to perform a decryption process upon the encrypted audio data;
wherein a data length of the encrypted audio data depends upon the format of the audio data.

12. The audio data transmitting method of claim 11, wherein the format of the audio data comprises at least one of a sampling rate, a number of bits per sample, and a number of audio channels.

13. The audio data transmitting method of claim 11, wherein performing the encryption process upon the audio data comprises:
selecting a data length from a plurality of candidate data lengths according to the format of the audio data; and
encrypting the audio data according to the encryption standard and the selected data length.

14. The audio data transmitting method of claim 11, further comprising:
playing the audio data decrypted by the audio device.

15. The audio data transmitting method of claim 11, wherein the encryption approach is an AES encryption standard.

16. The audio data transmitting method of claim 11, wherein the link standard is an HDA link.

17. The audio data transmitting method of claim 11, wherein the audio device is an audio CODEC.

18. The audio data transmitting method of claim 11, wherein the audio data is provided by a DVD optical disc storage device.
